(19) United States
(12) Patent Application Publication
(10) Pub. No.: US 2012/0299675 A1
(43) Pub. Date: Nov. 29, 2012

(54) ANISOTROPIC RARE EARTH MAGNET AND METHOD FOR PRODUCING THE SAME

(75) Inventors: Yoshinobu Honkura, Tokai-shi (JP); Chisato Mishima, Tokai-shi (JP)

(73) Assignee: AICHI STEEL CORPORATION, AICHI (JP)

(21) Appl. No.: 13/514,942

(22) PCT Filed: Aug. 27, 2010
(86) PCT No.: PCT/JP2010/064611

§ 371 Date: Aug. 9, 2012

(30) Foreign Application Priority Data
Dec. 9, 2009 (JP) 2009-279314

(51) Int. Cl. H01F 7/02; B22F 3/12; B22F 3/26; H01F 41/02

(52) U.S. Cl. 335/302; 419/62; 419/30; 419/27

(57) ABSTRACT

A method for producing an anisotropic rare earth magnet according to the present invention comprises a forming step of obtaining a formed body by press-forming a mixed raw material of a magnet raw material capable of generating R₂TM₁₄B₁-type crystals of a tetragonal compound of a rare earth element (R), boron (B), and a transition element (TM), and a diffusion raw material to serve as a supply source of at least a rare earth element (R′) and Cu; and a diffusing step of diffusing at least R′ and Cu onto surfaces or into crystal grain boundaries of the R₂TM₁₄B₁-type crystals by heating the formed body. In this production method, the diffusion raw material having a low melting point and high wettability envelops the R₂TM₁₄B₁-type crystals, and therefore an anisotropic rare earth magnet having high coercivity can be obtained without decreasing magnetization which should be inherently exhibited by the magnet raw material.

### TECHNICAL FIELD

The present invention relates to an anisotropic rare earth magnet having good magnetic characteristics and a method for producing the same.

### BACKGROUND ART

(Anisotropic) rare earth magnets comprising formed bodies obtained by compression-forming rare earth magnet powder or sintered bodies obtained by sintering the formed bodies exhibit very high magnetic characteristics. Therefore, the rare earth magnets are expected to be used in a variety of devices, such as electric appliances and automobiles which are desired to achieve energy saving and weight reduction.

However, in order to increase the use of the rare earth magnets, the rare earth magnets are needed to have high heat resistance capable of exhibiting stable magnetic characteristics even in a high-temperature environment. Therefore, research and development is actively carried out to improve coercivity of the rare earth magnets. Specifically, a lot of studies are now being made on diffusing scarce elements such as dysprosium (Dy) and terbium (Tb), which are effective in improving coercivity, from surfaces of the rare earth magnets. Description of these techniques is found in the following literature.

### CITATION LIST

### Patent Literature

[PTL 1] Japanese Examined Patent Publication No. H06-82575
[PTL 2] Japanese Unexamined Patent Publication No. H10-326705
[PTL 3] Japanese Unexamined Patent Publication No. 2001-76917
[PTL 4] Japanese Unexamined Patent Publication No. 2005-97711
[PTL 5] Japanese Unexamined Patent Publication No. 2003-301203
[PTL 6] Japanese Unexamined Patent Publication No. 2000-336405
[PTL 7] Japanese Patent No. 3452254 (Japanese Unexamined Patent Publication No. 2002-93610)
[PTL 8] Japanese Unexamined Patent Publication No. 2010-114200

### Non-Patent Literature

[NPL 1] Journal of the Japan Institute of Metals. Vol. 72, No. 12 (2008) pp. 1010-1014

### SUMMARY OF INVENTION

### Technical Problem

All the techniques disclosed in the above literature are to use scarce and expensive Dy as a coercivity-improving element or to make a coercivity-improving element directly contained in a magnet raw material.

It is an object of the present invention to provide a production method capable of obtaining an anisotropic rare earth magnet which can exhibit high coercivity while securing high magnetization, high residual magnetic flux density and the like without essentially using a scarce element such as Dy unlike in the aforementioned conventional techniques, and to provide an anisotropic rare earth magnet obtained by the production method.

### Solution to Problem

The present inventors have earnestly studied and repeated trial and error in order to solve the problem. As a result, the present inventors have newly found that a sintered magnet obtained by using a mixed raw material of a magnet raw material to generate R₂TM₁₄B₁-type crystals and a diffusion raw material comprising R′ and Cu exhibits high residual magnetic flux density and high coercivity. The present inventors have made further research on this finding and completed the following present invention.

<Method for Producing an Anisotropic Rare Earth Magnet>

(1) A method for producing an anisotropic rare earth magnet according to the present invention comprises a mixing step of obtaining a mixed raw material of a magnet raw material capable of generating R₂TM₁₄B₁-type crystals of a tetragonal compound of a rare earth element (hereinafter referred to as “R”), boron (B), and a transition element (hereinafter referred to as “TM”), and a diffusion raw material to serve as a supply source of at least a rare earth element (hereinafter referred to as “R′”) and Cu; a forming step of obtaining a formed body by pressing the mixed raw material; and a diffusing step of diffusing at least R′ and Cu onto surfaces or into crystal grain boundaries of the R₂TM₁₄B₁-type crystals by heating the formed body.

(2) The production method of the present invention can provide an anisotropic rare earth magnet which is excellent not only in coercivity but also in residual magnetic flux density and other magnetic characteristics can be obtained. In addition, the method of the present invention does not always need to employ scarce and expensive Dy or the like for the diffusion raw material and can employ an easily available and relatively inexpensive diffusion raw material comprising R′ such as Nd, and Cu. Therefore, an anisotropic rare earth magnet having high magnetic characteristics can be obtained stably at low costs.

Although mechanism in which the anisotropic rare earth magnet obtained by the production method of the present invention exhibits good magnetic characteristics is not all clear, at present it is assumed as follows. First of all, R′ as a single substance or Cu as a single substance has a high melting point, but their alloys generally have low melting points. Especially, melting points of alloys having approximate eutectic composition sharply decrease. Moreover, the melted alloys have very high wettability with respect to a tetragonal compound (R₂TM₁₄B₁-type crystals). Therefore, when the mixed raw material is heated, the diffusion raw material around the magnet raw material starts melting and R′ and Cu smoothly coat surfaces of the R₂TM₁₄B₁-type crystals as a main phase. Furthermore, R′ and Cu also diffuse into space between these crystals and form crystal grain boundaries which envelop the respective crystals (suitably referred to as “enveloping layers” or “a diffusion layer”).

As a result, the enveloping layers comprising R′ and Cu correct distortion present on the surfaces of the R₂TM₁₄B₁-type crystals and suppress reverse magnetic domain generation in the vicinity of the surfaces. Moreover, these enveloping layers can isolate each of the R₂TM₁₄B₁-type crystals and block magnetic interactions between the respective neighboring R₂TM₁₄B₁-type crystals. This is supposed to be how the production method of the present invention can provide an anisotropic rare earth magnet having a remarkably improved coercivity without decreasing magnetization which the magnet raw material inherently possesses.

(3) Magnetization exhibited by the magnet raw material is stronger, as the composition of the magnet raw material is closer to a theoretical composition necessary to form the R₂TM₁₄B₁-type crystals. Specifically, as the magnet raw material has a closer composition to a composition comprising 11.8 atomic % (at. %) of R, 5.9 at. % of B, and the remainder being TM (a more approximate theoretical composition), it is more preferred. Therefore, it is suitable that the magnet raw material has an approximate theoretical composition comprising 11.6 to 12.7 at. %, 11.8 to 12.5 at. %, or 11.8 to 12.4 at. % of R, and 5.5 to 7 at. % or 5.9 to 6.5 at. % of B when the entire magnet raw material is taken as 100 at. %. It should be noted that the remainder other than R and B is TM and part of B can be replaced with carbon (C). Of course, the magnet raw material and the diffusion raw material can contain “reforming elements”, which are effective in improving characteristics of the anisotropic rare earth magnet and “inevitable impurities”, which are difficult to be removed for costs or technical reasons.

(4) Preferably TM is at least one element of 3d transition elements with atomic numbers 21 (Sc) through 29 (Cu), and 4d transition elements with atomic numbers 39 (Y) through 47 (Ag). It is especially preferable that TM is iron (Fe), cobalt (Co) or nickel (Ni) in group VIII, and it is more preferable that TM is Fe. It should be noted that Co is an effective element in improving a Curie point, and enhances heat resistance of anisotropic rare earth magnets. Therefore, the anisotropic rare earth magnet can contain 0.5 to 5.4 at. % of Co when the entire anisotropic rare earth magnet is taken as 100 at. %. In this case, it is preferable that Co is supplied from at least one of the magnet raw material and the diffusion raw material. Besides, the anisotropic rare earth magnet can contain small amounts of reforming elements such as Nb, Zr, Ti, V, Cr, Mn, Ni, and Mo. It is preferable that the total amount of these reforming elements is not more than 2.2 at. % when the entire anisotropic rare earth magnet is taken as 100 at. %.

(5) By the way, Nd is typical as a rare earth element (R, R′), but the rare earth element (R, R′) can contain Pr. Even if part of Nd in the magnet raw material or the diffusion raw material is replaced with Pr, it gives little effect to magnetic characteristics and a mixed rare earth raw material of Nd and Pr (didymium) is available at relatively low costs. It is also preferable to suppress the use of coercivity-improving elements such as Dy, Tb and Ho because these elements are scarce and expensive. Therefore, it is suitable that the magnet raw material or the diffusion raw material according to the present invention does not contain Dy, Tb or Ho.

“R” and “R′” are used as terms representing specific name of one or more rare earth elements. “R” or “R′” means one or more kinds of elements of all the rare earth elements unless otherwise particularly mentioned, and “R” and “R′” can be of the same kind or of different kinds. In the present invention, one or more rare earth elements contained in the magnet raw material are referred to as “R” and one or more rare earth elements contained in the diffusion raw material are referred to as “R′” for the purpose of convenience. However, when attention is paid on an anisotropic rare earth magnet as a resultant product thereof, one or more rare earth elements constituting a tetragonal compound as a main phase of the magnet (i.e., R₂TM₁₄B₁-type crystals) are expressed as “R” and one or more rare earth elements diffused onto surfaces or into grain boundaries of the crystals are expressed as “R′” for the purpose of convenience. Therefore, R which has been discharged in forming a tetragonal compound and forms crystal grain boundaries or the like are expressed as “R′” for the purpose of convenience.

Specifically speaking, R or R′ is at least one of yttrium (Y), lanthanoid, and actinoid and typical examples of R or R′ include lanthanum (La), cerium (Ce), samarium (Sm), gadolinium (Gd), erbium (Er), thulium (Tm), and lutetium (Lu), in addition to Nd, Pr, Dy, Tb, Ho, and Y.

### Anisotropic Rare Earth Magnet

The present invention can be grasped as an anisotropic rare earth magnet obtained by the aforementioned production method. This anisotropic rare earth magnet can be a sintered anisotropic rare earth magnet formed by sintering magnet powder particles or a dense anisotropic rare earth magnet comprising a dense aggregate of the magnet powder particles.

### Others

(1) A range “x to y” mentioned in the description of the present invention includes a lower limit value x and an upper limit value y, unless otherwise particularly specified. Moreover, the various lower limit values and upper limit values mentioned in the description of the present invention can be arbitrarily combined to constitute such a range “a to b”. Furthermore, any given numerical value within the ranges mentioned in the description of the present invention can be used as an upper limit value or a lower limit value for setting a numerical value range.

(2) The average crystal grain diameter mentioned in the description of the present invention is determined by the method for measuring an average particle diameter d of crystal grains in JIS G 0551.

### DESCRIPTION OF EMBODIMENTS

The present invention will be described in more detail by way of embodiments of the present invention. What is discussed in the description of the present invention including the following embodiments can be applied not only to the method for producing an anisotropic rare earth magnet according to the present invention but also an anisotropic rare earth magnet obtained by the production method. Therefore, one or more constituents arbitrarily selected from those stated in the description of the present invention can be added to the abovementioned constitution of the present invention. In this case, constitution of the production method can be regarded as constitution of a product when understood as a product by process. It should be noted that which embodiment is best is different with application targets, required performance and so on.

### Production Method

The method for producing an anisotropic rare earth magnet according to the present invention comprises at least a mixing step, a forming step, and a diffusing step. Hereinafter, the respective steps will be described in detail.

### (1) Mixing Step

The mixing step of the present invention is a step of obtaining a mixed raw material of a magnet raw material capable of generating R₂TM₁₄B₁-type crystals of a tetragonal compound of R, B and TM, and a diffusion raw material to serve as a supply source of at least R′ and Cu. The magnet raw material and the diffusion raw material which comprise pulverized and classified powders are uniformly mixed by using a Henschel mixer, a rocking mixer, a ball mill or the like. Preferably the mixing is carried out in an oxidation-preventing atmosphere such as an inert gas atmosphere or a vacuum atmosphere.

Employable as the magnet raw material are, for example, ingot materials produced by casting molten metal prepared by a variety of melting methods (high frequency melting, arc melting, etc.), strip cast materials produced by strip casting such molten metal. It is especially preferable to use strip cast materials. The reason is as follows.

In order to obtain a very high residual magnetic flux density Br, it is preferable that the R content and the B content in the magnet raw material are close to stoichiometric composition values of a R₂TM₁₄B₁ compound (i.e., respectively have approximate theoretical composition values). However, when these contents have approximate theoretical composition values, αFe as a primary phase tends to remain present.

Especially in the case of ingot materials, due to a low cooling rate in casting, the soft magnetic αFe phase tends to remain present. In order to remove this αFe phase, soaking time need to be increased. This is inefficient, and magnetic characteristics tend to degrade. In contrast, in the case of strip cast materials, owing to a high cooling rate in casting, the soft magnetic αFe phase hardly remains present, and even when the soft magnetic αFe phase remains present, it is finely distributed. Therefore, the soft magnetic αFe phase can be removed in a short soaking time.

If the strip cast material is subjected to homogenization treatment, its crystal grains grow to a preferred average crystal grain diameter of about 100 μm (50 to 250 μm). If the thus obtained strip is pulverized, it is possible to obtain a magnet raw material in which there is no αFe phase, a R-rich phase is formed in grain boundaries and crystal grains have appropriate size.

The diffusion raw material can be an alloy or a chemical compound which contains at least R′ and Cu or a mixture of plural kinds of raw materials (including respective powder as a single substance) in accordance with desired composition. It is preferable that the diffusion raw material has a powdery shape obtained by applying hydrogen decrepitation and/or mechanical pulverization to an ingot material, a strip cast material or the like. The amount of the diffusion raw material is preferably 0.1 to 10% by mass or 1 to 6% by mass when the entire mixed raw material is taken as 100% by mass. An excessively small amount of diffusion raw material results in insufficient formation of the enveloping layers (the diffusion layer) which envelop the R₂TM₁₄B₁-type crystals. On the other hand, an excessively large amount of diffusion raw material decreases residual magnetic flux density of an anisotropic rare earth magnet.

At least one of the magnet raw material and the diffusion raw material can be a hydride. A hydride is a single substance, an alloy, a chemical compound or the like which hydrogen is bonded to or solid solved in. It should be noted that hydrogen in the raw materials is discharged with progression of the diffusing step at the latest, and accompanied by this hydrogen discharge, the diffusion raw material is melted and diffuses into the magnet raw material.

### (2) Forming Step

The forming step is a step of obtaining a formed body of a desired shape by pressing a mixed raw material put in a die cavity or the like. Forming pressure in this step is determined in consideration of a desired density of a formed body, subsequent steps and so on, and can be, for example, 1 to 10 ton/cm² (98 to 980 MPa).

The forming step can be single-time forming or multiple-time forming. It is preferable to select the times of forming in consideration of subsequent steps. For example, when a sintering step is executed after the forming step, an anisotropic rare earth magnet having a sufficiently high density can be obtained even by single-time forming because a liquid phase is generated among powder particles in sintering. Even if a formed body is not sintered, an anisotropic rare earth magnet having a high density can be obtained without difficulty by multiple-time forming. In this case, a pressing atmosphere (temperature), a pressing device and like can be changed at each forming time. Specifically speaking, the forming step can comprise a preforming step of obtaining a preform by pressing the mixed raw material at cold or warm temperature, and a densifying step of obtaining a dense formed body by pressing the preform at hot temperature. It is preferable in consideration of die life to form a preform under a low pressure at cold or warm temperature and then reform the preform at hot temperature into a dense formed body. It should be noted that the hot temperature means a temperature range above recrystallization temperature of R₂TM₁₄B₁-type crystals, the cold temperature means a temperature range around or below room temperature, and the warm temperature means a temperature range between these ranges.

When the magnet raw material comprises an anisotropic rare earth magnet powder, it is suitable that the forming step or the preforming step is a magnetic field forming step carried out in an oriented magnetic field. This can provide an anisotropic rare earth magnet in which easy magnetization axes (c-axes) of the R₂TM₁₄B₁-type crystals are oriented in a certain direction.

### (3) Diffusing Step

The diffusing step is a step of diffusing the diffusion raw material comprising at least R′ and Cu onto surfaces or into crystal grain boundaries of the R₂TM₁₄B₁-type crystals by heating the formed body comprising the mixed raw material. First of all, the diffusion raw material generally has a low melting point and good wettability with respect to the R TM₁₄B₁-type crystals, although depending on its total composition. Next, although diffusion is classified into surface diffusion, grain boundary diffusion and volume diffusion, the diffusion mentioned herein is mainly surface diffusion or grain boundary diffusion. Therefore, it is preferable that the diffusing step is a step of heating the formed body to a temperature at which the diffusion raw material is melted and performs surface diffusion and grain boundary diffusion.

The diffusing step is carried out, for example, in an oxidation-preventing atmosphere (e.g., a vacuum atmosphere, an inert atmosphere) at a temperature from 400 to 900 deg. C. An excessively low heating temperature is not preferred because diffusion does not proceed. An excessively high heating temperature is not preferred because the R₂TM₁₄B₁-type crystals become coarse. The diffusion raw material suitable for this diffusing step is, for example, a material which contains 2 to 43 at. % of Cu and arbitrarily contains 2.6 to 64 at. % of Al when the entire diffusion raw material is taken as 100 at. %. In this case, the heating temperature is preferably from 600 to 850 deg. C. The diffusion raw material can contain Co, Ni, Si, Mn, Cr, Mo, Ti, V, Ga, Zr, Ge, Fe and the like instead of Al or together with Al. The total amount of these elements is preferably 5 to 64 at. % when the entire diffusion raw material is taken as 100 at. %.

By the way, since the diffusing step only has to be a step of heating the formed body in a predetermined temperature range, another step carried out in this temperature range can serve as at least part of the diffusing step. For example, the aforementioned densifying step, the sintering step or the anisotropic orientation step mentioned later can serve as part of the diffusion step, and in such a case, these steps are respectively referred to as a diffusing and densifying step, a diffusing and sintering step, and a diffusion and anisotropic orientation step.

### (4) Sintering Step

A sintered anisotropic rare earth magnet is obtained by sintering the formed body by further heating. Especially when the formed body obtained by magnetic field forming is sintered, a sintered (anisotropic) rare earth magnet having high magnetic characteristics, high strength and high heat resistance can be obtained. It should be noted that, when the formed body is sintered in a furnace, sintering temperature is preferably not more than 1,100 deg. C. or not more than 1,050 deg. C. in order to suppress R₂TM₁₄B₁-type crystal grain coarsening. Besides, SPS (spark plasma sintering) can be used for sintering.

### (5) Anisotropic Orientation Step

The anisotropic orientation step is a step for obtaining an anisotropic rare earth magnet by giving anisotropy to a formed body comprising an isotropic magnet raw material (isotropic rare earth magnet powder). Specifically, the anisotropic orientation step is a step of subjecting the formed body to processing for aligning easy magnetization axes (c-axes) of the R₂TM₁₄B₁-type crystals in a certain direction. In this case, the c-axes of the R₂TM₁₄B₁-type crystals are oriented in the same direction as a processing stress application direction.

The processing in the anisotropic orientation step is powerful, so hot working is preferred. With hot working, crystal orientation of the R₂TM₁₄B₁-type crystals can be easily aligned. Hot working includes hot extrusion, hot drawing, hot forging, hot rolling, etc., and these operations can be executed singly or in a combination thereof. It should be noted that if the formed body subjected to the anisotropic orientation step is the aforementioned dense formed body, an anisotropic dense body can be obtained and serve as a dense anisotropic rare earth magnet having high density and good magnetic characteristics.

### (6) Anisotropic Rare Earth Magnet Powder

Anisotropic rare earth magnet powder is obtained, for example, by applying a well-known hydrogen treatment to a magnet alloy as a base material (a base alloy). This hydrogen treatment comprises a disproportionation step of causing a base alloy to absorb hydrogen and undergo a disproportionation reaction, and a recombination step of dehydrating and recombining the base alloy after this disproportionation step, and is called HDDR (hydrogenation-decomposition (or disproportionation)-desorption-recombination) or d-HDDR (dynamic-hydrogenation-decomposition (or disproportionation)-desorption-recombination).

For example, in the case of d-HDDR, the disproportionation step comprises at least a high-temperature hydrogenation step, and the recombination step comprises at least a dehydrogenation step (more specifically, a controlled exhaust step). Hereinafter, the respective steps of the hydrogen treatment will be described.

(a) A low-temperature hydrogenation step is a step of allowing the magnet alloy to absorb and incorporate in solid solution a sufficient amount of hydrogen in a low temperature range below temperatures at which a hydrogenation reaction or a disproportionation reaction occurs, so that hydrogenation and disproportionation reactions in the following step (a high-temperature hydrogenation step) gently proceed. More specifically speaking, the low-temperature hydrogenation step is a step of allowing the magnet alloy of the magnet raw material to absorb hydrogen by holding the magnet alloy in a hydrogen gas atmosphere below a disproportionation reaction temperature (e.g., below 600 deg. C.). Upon performing this step beforehand, reaction rate of forward structural transformation in the subsequent high-temperature hydrogenation step can be controlled easily.

An excessively high temperature of the hydrogen gas atmosphere causes the magnet alloy to undergo partial structure transformation and have a non-uniform structure. Hydrogen pressure in the low-temperature hydrogenation step is not particularly limited, and can be, for example, about 0.03 to 0.1 MPa. It should be noted that the hydrogen gas atmosphere can be a mixed gas atmosphere of hydrogen gas and an inert gas. Hydrogen pressure in this case is hydrogen gas partial pressure. The same applies to those in the high-temperature hydrogenation step and the controlled exhaust step.

(b) The high-temperature hydrogenation step is a step of causing the magnet alloy to undergo hydrogenation and disproportionation reactions. Specifically speaking, the high-temperature hydrogenation step is a step of holding the magnet alloy after the low-temperature hydrogenation step in a hydrogen gas atmosphere under 0.01 to 0.06 MPa at 750 to 860 deg. C. This high-temperature hydrogenation step causes the magnet alloy after the low-temperature hydrogenation step to have a structure decomposed into three phases (αFe phase, RH₂ phase, Fe₂B phase). In this case, since the magnet alloy already absorbs hydrogen in the low-temperature hydrogenation step, the structure transformation reaction can gently proceed under suppressed hydrogen pressure.

When hydrogen pressure is excessively small, the reaction rate is small, so untransformed structure remains present and coercivity decreases. When hydrogen pressure is excessively high, the reaction rate is high, so the anisotropy ratio decreases. When the temperature of the hydrogen gas atmosphere is excessively low, the structure decomposed into the three phases tends to be non-uniform and coercivity decreases. When that temperature is excessively high, crystal grains become coarse and coercivity decreases. It should be noted that hydrogen pressure or temperature in the high-temperature hydrogenation step does not have to be constant all the time. For example, reaction rate can be controlled by increasing at least one of hydrogen pressure and temperature at a last part of the step, at which the reaction rate decreases, so as to promote three-phase decomposition (a structure stabilization step).

(c) The controlled exhaust step is a step of causing the structure decomposed into the three phases in the high-temperature hydrogenation step to undergo a recombination reaction. In this controlled exhaust step, dehydration is gently carried out and a recombination reaction gently proceeds under a relatively high hydrogen pressure. More specifically speaking, the controlled exhaust step is a step of holding the magnet alloy after the high-temperature hydrogenation step in a hydrogen gas atmosphere under a hydrogen pressure of 0.7 to 6.0 kPa at 750 to 850 deg. C. Owing to this controlled exhaust step, hydrogen is removed from the RH₂ phase of the aforementioned three decomposed phases. Thus the structure recombines and a hydride of fine R₂TM₁₄B₁-type crystals (RFeBHₓ) onto which crystal orientation of the Fe₂B phase is transcribed is obtained. When hydrogen pressure is excessively small, hydrogen removal is drastic and magnetic flux density decreases. When the hydrogen pressure is excessively high, the above-mentioned reverse transformation is insufficient and coercivity may decrease. When treatment temperature is excessively low, the reverse transformation reaction does not appropriately proceed. When the treatment temperature is excessively high, crystal grains become coarse. It should be noted that if the high-temperature hydrogenation step and the controlled exhaust step are carried at almost the same temperature, a shift from the high-temperature hydrogenation step to the controlled exhaust step can be easily achieved only by changing the hydrogen pressure.

(d) The forced exhaust step is a step of removing hydrogen remaining in the magnet alloy to complete dehydrogenation treatment. Treatment temperature, degree of vacuum and so on of this step are not particularly limited, but this step is preferably carried out in a vacuum atmosphere under not more than 1 Pa at 750 to 850 deg. C. When treatment temperature is excessively low, a lot of time is required for exhaust. When the treatment temperature is excessively high, crystal grains become coarse. When the degree of vacuum is excessively small, hydrogen may remain present and magnetic characteristics of a resulting anisotropic rare earth magnet powder may decrease. It is preferable to rapidly cool the magnet alloy after this step, because crystal grain growth is suppressed.

The forced exhaust step does not have to be conducted continuously after the controlled exhaust step. A cooling step of cooling the magnet alloy after the controlled exhaust step can be conducted before the forced exhaust step. If the cooling step is provided, the forced exhaust step to be performed on the magnet alloy after the controlled exhaust step can be carried out by batch processing. The magnet alloy (the magnet raw material) in the cooling step is a hydride and has oxidation resistance. Therefore, it is possible to temporarily take out the magnet raw material into the air.

Particles of the thus obtained anisotropic rare earth magnet powder comprise agglomerates of fine R₂TM₁₄B₁-type crystals having an average crystal grain diameter of 0.01 to 1 μm. It should be noted that particles comprising agglomerates of fine R TM₁₄B₁-type crystals having an average grain diameter of about 0.03 μm can be obtained by liquid quenching, but these particles are isotropic. Therefore, application of the aforementioned anisotropic orientation treatment is preferred in order to obtain an anisotropic rare earth magnet from the isotropic magnet powder.

It should be noted that the magnet raw material to be used in the mixing step preferably has an average particle diameter of 3 to 200 μm. The diffusion raw material preferably has an average particle diameter of 3 to 30 μm. When the average particle diameter is excessively small, these raw materials are uneconomical and not easy to handle. On the other hand, when the average particle diameter is excessively great, it is difficult to uniformly mix these two raw materials.

### INDUSTRIAL APPLICABILITY

Application purposes of the anisotropic rare earth magnet of the present invention are not limited, and the magnet can be used in a variety of devices. The use of this anisotropic rare earth magnet achieves energy saving, weight and size reduction, performance enhancement and so on of the devices.

### EXAMPLES

The present invention will be described more specifically by way of examples.

### Example 1

### Sintering Process: Specimen Nos. 1 and C1

### Specimen Production

(1) Raw Material Preparation (Mixing Step)

First, raw materials were weighed so as to have the composition shown in specimen No. 1 in Table 1 (an approximate theoretical composition) and melted and cast by strip casting, thereby obtaining a magnet alloy (a base alloy). Then the magnet alloy was held in a hydrogen atmosphere under 1.3 atm, thereby subjected to hydrogen decrepitation. The thus obtained coarse powder was further pulverized by a jet mill, thereby obtaining fine powder having an average particle diameter of 5 μm. This fine powder was used as a magnet raw material.

Next, raw materials were weighed so as to have composition comprising 80% by mass Nd-10% by mass Cu-10% by mass Al (51.3 at. % Nd-14.5 at. % Cu-34.2 at. % Al) and melted and cast by book molding, thereby obtaining an ingot. The ingot was held in a hydrogen atmosphere under 1.3 atm, thereby subjected to hydrogen embrittlement. The obtained material was further pulverized by a wet ball mill, thereby obtaining fine powder (a hydride) of 5 μm or less. This fine powder was used as a diffusion raw % material. Then the aforementioned magnet raw material and the diffusion raw material were uniformly mixed by a mixer in an inert gas (Ar) atmosphere (a mixing step), thereby obtaining a mixed raw material. The diffusion raw material was added in 6% by mass when the entire mixed raw material was taken as 100% by mass.

(2) Forming Step (Magnetic Field Forming Step)

The mixed raw material was put in a die and pressed by a pressure of 1 ton/cm² while a magnetic field of 25 kOe (1990 kA/m) was applied thereto. Thereby obtained was a block-shaped formed body (a 7 mm cube).

(3) Diffusing Step and Sintering Step

This formed body was heated to around 800 deg. C. and held at that temperature for 0.5 hour in an inert gas atmosphere (a diffusing step). This formed body was further heated at 1,000 deg. C. for one hour, thereby obtaining a sintered body (a sintering step). This sintering step is a diffusing and sintering step which serves also as part of the diffusing step.

(4) Aging Step

The sintered body after the sintering step was rapidly cooled to a room temperature range in the Ar atmosphere. Then, aging treatment was applied by heating the sintered body at 500 deg. C. for 0.5 hour. With this structure control by the heat treatment, a sintered anisotropic rare earth magnet having good magnetic characteristics was obtained.

(5) A magnet alloy which was made to contain Cu and Al from an initial stage by, what is called, ingot process and controlled to have the composition shown in specimen No. C1 in Table 1 was prepared as a comparative specimen. A sintered anisotropic rare earth magnet produced by using only a magnet raw material comprising this magnet alloy (i.e., not using any diffusion raw material) was also prepared by a similar method to the aforementioned method, except that sintering temperature in this case was 1,050 deg. C. It should be noted that the magnet raw material used in producing the comparative specimen had an optimum composition for producing a sintered anisotropic rare earth magnet having high magnetic characteristics when Cu and Al were added into the ingot. The same applied to those of comparative specimens of Examples 2 and 3 mentioned later.

### Measurement

The respective sintered anisotropic rare earth magnets were magnetized in a magnetic field of about 3600 kA/m (45 kOe), and their magnetic characteristics were measured by a B-H tracer. Results are also shown in Table 1. It should be noted that analysis by inductively coupled plasma-optical emission spectrometry (ICP-OES) revealed that the sintered anisotropic rare earth magnet of specimen No. 1 had component composition (overall composition) comprising Fe-13.7% Nd-5.9% B-0.6% Cu-1.4% Al (at. %).

### Evaluation

As apparent from Table 1, specimen No. 1 in which the Nd—Cu—Al alloy was diffused had a remarkably higher coercivity than specimen No. C1 in which Cu and Al were contained in the magnet raw material from the initial stage.

### Example 2

### Hot Working Process: Specimen Nos. 2 and C2

(1) Raw Material Preparation (Mixing Step)

First, an ingot was obtained by weighing raw materials so as to have the composition shown in specimen No. 2 in Table 1 (an approximate theoretical composition) and casting the raw materials by button arc melting. A magnet alloy (a base alloy) was obtained by casting this ingot by a single roll liquid quenching method. Then heat treatment was applied to the magnet alloy at 800 deg. C. for 10 minutes in an inert gas temperature, thereby obtaining an isotropic ribbon having a crystal grain diameter of 0.02 to 0.04 μm. Furthermore, this ribbon was pulverized by a ball mill, thereby obtaining magnet powder having an average particle diameter of 100 μm. This magnet powder was used as a magnet raw material. Next, the same diffusion raw material as that of Example 1 was added to this magnet raw material in 6% by mass and mixed by a similar method to that of Example 1, thereby obtaining a mixed raw material.

(2) Forming Step and Diffusing Step

This mixed raw material was put in a die and pressed by a pressure of 3 ton/cm² in a room temperature (cold temperature) range, thereby obtaining a block-shaped preform (a 14 mm cube) (a preforming step). This preform was pressed by a hot press machine under 2 ton/cm² at 700 deg. C. (hot temperature) for 10 seconds, thereby obtaining a dense formed body (a densifying step). This dense formed body was heated at the same temperature (700 deg. C.) in an inert gas atmosphere for 5 minutes (a diffusing step). The dense formed body at this time had a density of 7.5 g/cm³. It should be noted that the densifying step was a diffusing and densifying step which served also as part of the diffusing step.

(3) Anisotropic Orientation Step The dense formed body was further hot-worked (i.e., hot-extruded) at 750 deg. C. (hot temperature) under 7 ton/cm², thereby obtaining a plate-shaped anisotropic dense body. It should be noted that the diffusing step had finished before the anisotropic orientation step in this example, but when the diffusing step is not completed, the anisotropic orientation step can be a diffusion and anisotropic orientation step which serves also as part of the diffusing step.

(4) An anisotropic dense body comprising only a magnet raw material which was prepared so as to have the composition shown in specimen No. C2 in Table 1 was also produced as a comparative specimen by a similar method to the aforementioned method without using any diffusion raw material.

### Measurement and Evaluation

Anisotropic dense rare earth magnets were obtained by cutting a 7 mm cube out of each of the plate-shaped anisotropic dense bodies. Magnetic characteristics of the thus obtained anisotropic dense rare earth magnets were measured by a similar method to that of Example 1 and results are also shown in Table 1. A comparison between specimen Nos. 2 and C2 shows that the same can be said as in Example 1.

### Example 3

### Hot Compressing Process: Specimen Nos. 3 and C3

(1) Raw Material Preparation (Mixing Step)

First, raw materials were weighed so as to have the composition shown in Table 1 (an approximate theoretical composition) and melted and cast by strip casting, thereby obtaining a magnet alloy (a base alloy). This magnet alloy was held in an Ar gas atmosphere at 1,140 deg. C. for 10 hours, thereby homogenizing structure (a homogenization heat treatment step).

Hydrogenation treatment (d-HDDR) was applied to the magnet alloy after subjected to hydrogen decrepitation, thereby obtaining a powdery magnet raw material. This hydrogenation treatment was conducted as follows.

The magnet alloy was put in a treatment furnace and held in a low-temperature hydrogen atmosphere at room temperature under 0.1 MPa for one hour (a low-temperature hydrogenation step). Subsequently, the magnet alloy was held at 780 deg. C. under 0.03 MPa for 30 minutes (a high-temperature hydrogenation step). Then, the temperature of the atmosphere was increased to 840 deg. C. over 5 minutes and the magnet alloy was held at 840 deg. C. under 0.03 MPa for 60 minutes (a structure stabilization step). While thus controlling reaction rate, forward transformation of decomposing the magnet alloy into three phases (α-Fe, RH₂, Fe₂B) was caused (a disproportionation step). Then, hydrogen was continuously exhausted from the treatment furnace and the magnet alloy was held at 840 deg. C. under 1 kPa for 90 minutes, thereby causing reverse transformation of generating R₂TM₁₄B₁-type crystals in the magnet alloy after the forward transformation (a controlled exhaust step/a recombination step).

Subsequently, the magnet alloy was rapidly cooled (a first cooling step). The cooled magnet alloy was held at 840 deg. C. under not more than 10⁻¹ Pa for 30 minutes, thereby completely dehydrogenated (a forced exhaust step). The thus obtained magnet alloy was pulverized in a mortar in an inert gas atmosphere and then subjected to grain size control, thereby obtaining a powdery magnet raw material having an average particle diameter of 100 μm. The same diffusion raw material as that of Example 1 was added in 6% by mass to this magnet raw material and mixed by a similar method to that of Example 1, thereby obtaining a mixed raw material. It should be noted that the diffusion raw material had a powder particle diameter of 7 μm or less.

It should be noted that the average particle diameter of powder particles mentioned in the description of the present invention was measured by a laser diffraction particle size distribution measuring device Helos & Rodos. (The same measurement method was employed in the following examples.) Moreover, the abovementioned magnet powder in itself had a coercivity (iHc) of 0.8 kOe (64 kA/m) and a saturation magnetization of 15.2 kG (1.52 T) in a magnetic field of 50 kOe (3979 kA/m).

(2) Forming Step and Diffusing Step

This mixed raw material was put in a die and pressed by a pressure of 4 ton/cm² in a room temperature (cold temperature) range, while a magnetic field of 25 kOe (1990 kA/m) was applied thereto. Thus obtained was a block-shaped preform (a 10 mm cube) (a preforming step/a magnetic field forming step).

This preform was pressed by a hot press machine at 700 deg. C. (hot temperature) under 2 ton/cm² for 10 seconds, thereby obtaining a dense formed body (a densifying step). This dense formed body was heated at the same temperature (700 deg. C.) in an inert gas atmosphere for 5 minutes (a diffusing step). The dense formed body at this time had a density of 7.5 g/cm³. It should be noted that the densifying step was a diffusing and densifying step which served also as part of the diffusing step.

(3) A dense formed body comprising only a magnet raw material which was prepared so as to have the composition shown in specimen No. C3 in Table 1 was produced as a comparative specimen by a similar method to the aforementioned method without using any diffusion raw material.

### Measurement and Evaluation

Dense anisotropic rare earth magnets were obtained by cutting a 7 mm cube out of each of the plate-shaped dense formed bodies. Magnetic characteristics of the respective obtained dense anisotropic rare earth magnets were measured by a similar method to that of Example 1 and results are also shown in Table 1. A comparison between specimen Nos. 3 and C3 shows that the same can be said as in Examples 1 and 2.

TABLE 1

| | PRODUCTION | | MAGNET RAW | | | | | | MAGNETIC | | |
|---|---|---|---|---|---|---|---|---|---|---|---|
| | METHOD OF | DIFFUSION | MATERIAL COMPOSITION | | | | | | CHARACTERISTICS | | |
| SPECIMEN | RARE EARTH | RAW | (at. %) | | | | | | iHc | Br | (BH)max |
| NO. | MAGNET | MATERIAL | Nd | Nb | B | Cu | Al | Fe | (kA/m) | (T) | (kJ/m³) |
| 1 | SINTERING | USED | 12 | — | 6.2 | — | — | bal. | 1432 | 1.39 | 382 |
| C1 | | NOT USED | 14 | — | 6 | 0.1 | 0.5 | | 1035 | 1.39 | 358 |
| 2 | HOT WORKING | USED | 12 | — | 6.2 | — | — | bal. | 1432 | 1.35 | 358 |
| C2 | (ANISOTROPIC | NOT USED | 13.4 | — | 5.4 | 0.1 | 2.4 | | 1114 | 1.35 | 342 |
| | ORIENTATION) | | | | | | | | | | |
| 3 | HOT | USED | 12 | 0.2 | 6.5 | — | — | bal. | 1385 | 1.31 | 318 |
| C3 | COMPRESSION | NOT USED | 13.4 | 0.2 | 5.4 | 0.1 | 2.4 | | 1114 | 1.29 | 302 |
| | (DENSIFICATION) | | | | | | | | | | |

DIFFUSION RAW MATERIAL COMPOSITION: Nd80%—Cu10%—Al 10% (% by mass)/Nd51.3%—Cu14.5%—Al34.2% (at. %)
MIXING RATIO: 6% by mass

1. A method for producing an anisotropic rare earth magnet comprising:
a mixing step of obtaining a mixed raw material of a magnet raw material capable of generating R₂TM₁₄B₁-type crystals of a tetragonal compound of a rare earth element (hereinafter referred to as “R”), boron (B), and a transition element (hereinafter referred to as “TM”), and a diffusion raw material to serve as a supply source of at least a rare earth element (hereinafter referred to as “R′”) and Cu;
a forming step of obtaining a formed body by pressing the mixed raw material; and
a diffusing step of diffusing at least R′ and Cu onto surfaces or into crystal grain boundaries of the R₂TM₁₄B₁-type crystals by heating the formed body.

2. The method for producing the anisotropic rare earth magnet according to claim 1, wherein:
the magnet raw material comprises anisotropic rare earth magnet powder;
the forming step is a magnetic field forming step carried out in an oriented magnetic field;
the method further comprises a sintering step of obtaining a sintered body by heating the formed body; and
the anisotropic rare earth magnet is a sintered anisotropic rare earth magnet comprising the sintered body.

3. The method for producing the anisotropic rare earth magnet according to claim 2, wherein the sintering step is a diffusing and sintering step which serves also as at least part of the diffusing step.

4. The method for producing the anisotropic rare earth magnet according to claim 1, wherein:
the forming step comprises:
a preforming step of obtaining a preform by pressing the mixed raw material at cold or warm temperature; and
a densifying step of obtaining a dense formed body by pressing the preform at hot temperature; and
the anisotropic rare earth magnet is a dense anisotropic rare earth magnet comprising the dense formed body.

5. The method for producing the anisotropic rare earth magnet according to claim 4, wherein the densifying step is a diffusing and densifying step which serves also as at least part of the diffusing step.

6. The method for producing the anisotropic rare earth magnet according to claim 4, wherein the magnet raw material comprises isotropic rare earth magnet powder,
the method further comprises an anisotropic orientation step of hot working the dense formed body, thereby obtaining an anisotropic dense formed body in which easy magnetization axes (c-axes) of the R₂TM₁₄B₁-type crystals are oriented in a certain direction, and
the anisotropic rare earth magnet is an anisotropic dense rare earth magnet comprising the anisotropic dense formed body.

7. The method for producing the anisotropic rare earth magnet according to claim 6, wherein the anisotropic orientation step is a diffusion and anisotropic orientation step which serves also as at least part of the diffusing step.

8. The method for producing the anisotropic rare earth magnet according to claim 4, wherein the magnet raw material comprises anisotropic rare earth magnet powder, and
the preforming step is a magnetic field forming step carried out in an oriented magnetic field.

9. The method for producing the anisotropic rare earth magnet according to claim 8, wherein the anisotropic rare earth magnet powder is obtained through:
a disproportionation step of causing a base alloy which is to become the magnet raw material to absorb hydrogen and undergo a disproportionation reaction; and
a recombination step of dehydrogenating and recombining the base alloy after the disproportionation step.

10. The method for producing the anisotropic rare earth magnet according to claim 9, wherein the anisotropic rare earth magnet powder is obtained further through a low-temperature hydrogenation step of allowing the base alloy to absorb hydrogen in a low temperature range below temperatures at which the disproportionation reaction occurs, before the disproportionation step.

11. The method for producing the anisotropic rare earth magnet according to claim 1, wherein the magnet raw material has an approximate theoretical composition comprising 11.6 to 12.7 atomic % (at. %) of R and 5.5 to 7 at. % of B when the entire magnet raw material is taken as 100 at. %.

12. The method for producing the anisotropic rare earth magnet according to claim 1, wherein the diffusion raw material contains 2 to 43 at. % of Cu and optionally contains 2.6 to 64 at. % of Al when the entire diffusion raw material is taken as 100 at. %.

13. The method for producing the anisotropic rare earth magnet according to claim 1, wherein the rare earth element (R and/or R′) is any rare earth element other than dysprosium (Dy), terbium (Tb), and holmium (Ho).

14. The method for producing the anisotropic rare earth magnet according to claim 1, wherein the rare earth element comprises neodymium (Nd) and optionally contains praseodymium (Pr).

15. An anisotropic rare earth magnet obtained by the production method according to claim 1.
